(19) United States
(12) Patent Application Publication
(10) Pub. No.: US 2026/0154213 A1
(43) Pub. Date: Jun. 4, 2026

(54) PRIORITIZING COMMANDS IN A COMMAND QUEUE FOR A SYSTEM MEMORY MANAGEMENT UNIT

(71) Applicant: QUALCOMM Incorporated, San Diego, CA (US)

(72) Inventors: Swapnil Kailas KAUTHALE, Hyderabad (IN); Debankan ROY, Kolkata (IN); Naresh Kumar SHARMA, Hyderabad (IN)

(21) Appl. No.: 18/967,151

(22) Filed: Dec. 3, 2024

(51) Int. Cl. G06F 13/18; G06F 9/455; G06F 13/16

(52) U.S. Cl. CPC G06F 13/18; G06F 9/45558; G06F 13/1626; G06F 2009/45579

(57) ABSTRACT

A method for prioritizing commands in a command queue of a system memory management unit is provided. The method includes obtaining a first set of commands originating from a first virtual machine of a plurality of virtual machines and a second set of commands originating from a second virtual machine of the plurality of virtual machines, each of the plurality of virtual machines having a different priority ranking. The method further includes inserting the first set of commands and the second set of commands into the command queue of the system memory management unit based on the priority ranking of the first virtual machine and the priority ranking of the second virtual machine.

Aspects of the present disclosure generally relate to system memory management units and, more particularly, to techniques for prioritizing commands (e.g., memory management requests) in a command queue for a system memory management unit based on a priority of virtual machines (e.g., safe VMs and non-safe VMs) generating the commands.

### BACKGROUND

A system memory management unit (SMMU) is a hardware component that manages the memory access and translation for a system-level device, such as a system-on-a-chip (SoC). For instance, the SMMU provides address translation capabilities by converting virtual addresses used by various components (e.g., central processing units, graphics processing units, direct memory access engines, etc.) of the system-level device. This allows the different components of the system-level device to have their own independent virtual address space. The SMMU also provides memory protection by controlling the access permissions (e.g., read, write) for each virtual-to-physical address translation to prevent unauthorized access to memory regions by the different components of the system-level device. The SMMU can also detect and handle various memory-related faults, such as page faults, access violations, and translation errors, and can report these faults for appropriate error handling and recovery by software for the system-level device.

### BRIEF SUMMARY

In one aspect, a method performable by a hypervisor is provided. The method includes obtaining a first set of commands originating from a first virtual machine of a plurality of virtual machines and a second set of commands originating from a second virtual machine of the plurality of virtual machines, each of the plurality of virtual machines having a different priority ranking; and inserting the first set of commands and the second set of commands into a command queue of a system memory management unit (SMMU) based on the priority ranking of the first virtual machine and the priority ranking of the second virtual machine.

In another aspect, an apparatus is provided. The apparatus includes: a system memory management unit comprising a command queue; and a hypervisor configured to: obtain a first set of commands originating from a first virtual machine of a plurality of virtual machines and a second set of commands originating from a second virtual machine of the plurality of virtual machines, each of the plurality of virtual machines having a different priority ranking; and insert the first set of commands and the second set of commands into the command queue of the system memory management unit based on the priority ranking of the first virtual machine and the priority ranking of the second virtual machine.

In yet another aspect, an apparatus is provided. The apparatus includes: means for obtaining a first set of commands originating from a first virtual machine of a plurality of virtual machines and a second set of commands originating from a second virtual machine of the plurality of virtual machines, each of the plurality of virtual machines having a different priority ranking; and means for inserting the first set of commands and the second set of commands into a command queue of a system memory management unit (SMMU) based on the priority ranking of the first virtual machine and the priority ranking of the second virtual machine.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 depicts a block diagram of an example architecture for a system memory management unit according to some aspects of the present disclosure.

FIG. 2 depicts various states of a command queue for a system memory management unit according to some aspects of the present disclosure.

FIG. 3A depicts a system for prioritizing commands from virtual machines in a first state according to some aspects of the present disclosure.

FIG. 3B depicts a system for prioritizing commands from virtual machines in a second state according to some aspects of the present disclosure.

FIG. 3C depicts a system for prioritizing commands from virtual machines of a system-level device in a third state according to some aspects of the present disclosure.

FIG. 4A depicts a sequence diagram for prioritizing commands for a command queue of a SMMU according to some aspects of the present disclosure.

FIG. 4B depicts another sequence diagram for prioritizing commands for a command queue of a SMMU according to some aspects of the present disclosure.

FIG. 5 depicts a flowchart of a method for prioritizing commands for a command queue of a SMMU according to some aspects of the present disclosure.

FIG. 6 depicts an example processing system in which the system of FIGS. 3A-3C may be included according to various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques and systems for prioritizing commands in a command queue of a SMMU.

Example aspects of the present disclosure are directed to SMMUs. SMMUs include a command queue that buffers multiple memory management requests (e.g., address translations, access permission updates, etc.) from different components of a system-level device. The command queue is generally a first-in-first-out (FIFO) queue in which memory management requests are processed in the order in which they are received. Thus, in existing command queues, a high-priority (e.g., time-sensitive) memory management request inserted into the command queue after a lower-priority (e. g, not time-sensitive) memory management request will not preempt (e.g., be processed ahead of) the lower-priority memory management request. This delay in processing the high-priority memory management request can, in some instances, affect the operation of the system-level device, especially when the high-priority memory management request is associated with a time-sensitive operation (e.g., signal processing associated with sensors, RADAR, navigation, cameras).

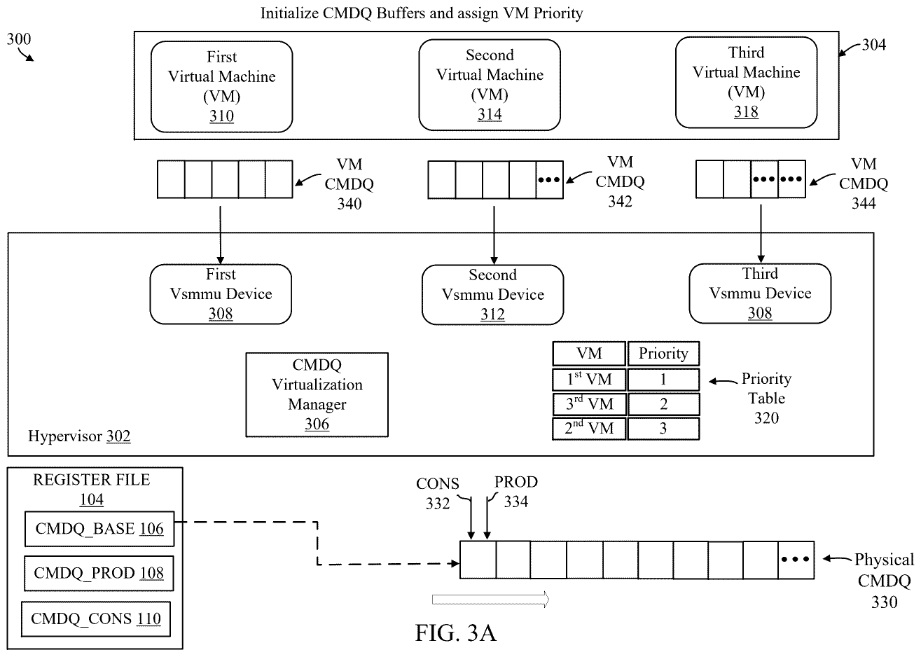

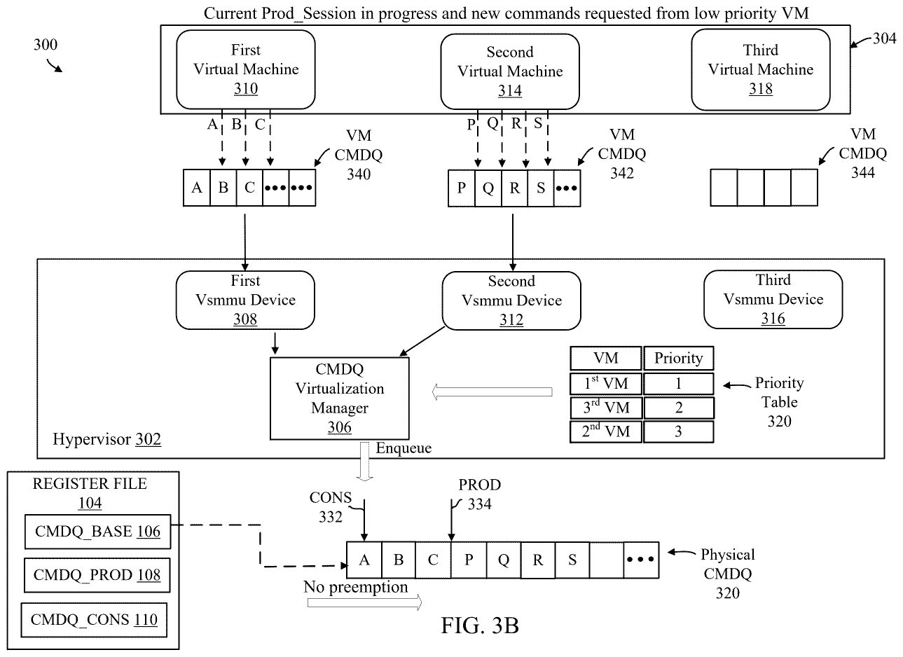

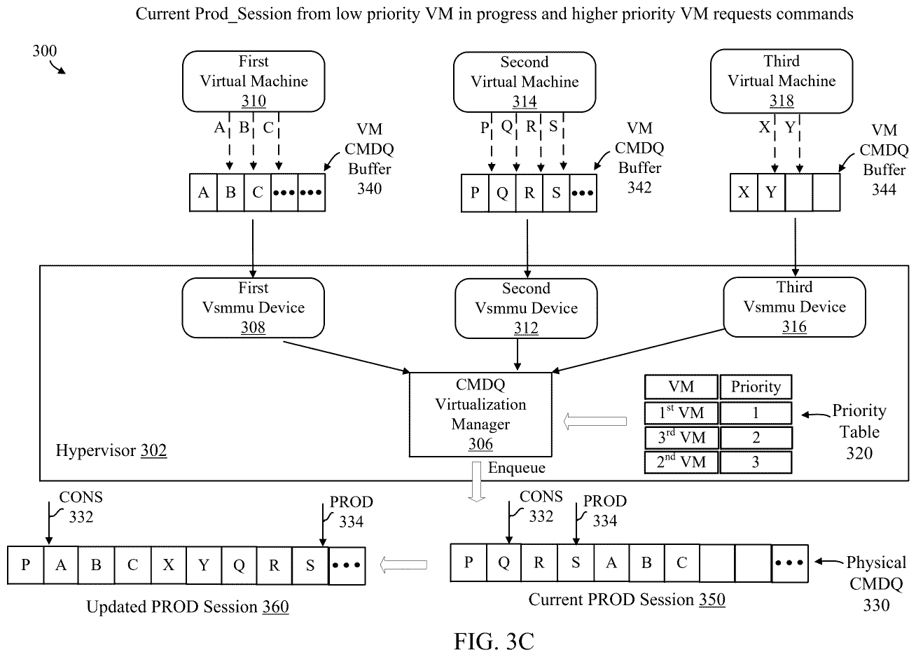

Example aspects of the present disclosure are directed to techniques for prioritizing memory management requests in the command queue of a SMMU. For instance, as will be discussed with reference to FIGS. 3A-3C, the disclosed techniques may include a hypervisor that receives memory management requests from different virtual machines (VMs) of the system-level device and manages the command queue to prioritize the different memory management requests. For instance, the hypervisor, specifically a command queue virtualization manager thereof, may manage the command queue to prioritize a memory management request from a high-priority VM (e.g., safe VM) over memory management requests from a low-priority VM (e.g., non-safe VM) that are already inserted in the command queue. In this manner, by prioritizing memory management requests from high-priority VMs over memory management requests from low-priority VMs, the disclosed techniques eliminate (or at least reduce) delays associated with consuming (e.g., processing) such high-priority memory management requests in existing SMMUs, leading to improved performance of the system-level device.

### Example System Memory Management Unit

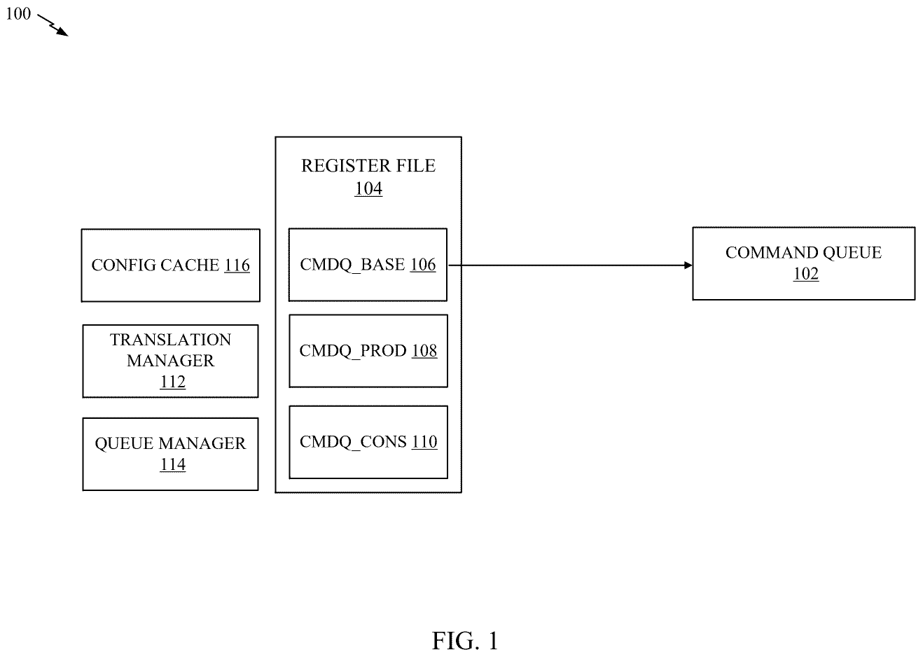

FIG. 1 depicts a block diagram of components of a SMMU 100 for a system-level device (e.g., SoC) according to some aspects of the present disclosure.

The SMMU 100 includes a command queue 102 (e.g., a circular queue) that serves as an input for the SMMU 100. More specifically, the command queue 102 may be a data structure (e.g., queue) that stores the various commands (e.g., memory management requests) submitted by the various components of the system-level device. The command queue 102 may store commands (e.g., memory management requests) that are executed by hardware and may include commands, such as configuration structure invalidation and table invalidation. In some aspects, the command queue 102 may be stored in memory, such as double data rate (DDR) memory.

The SMMU 100 may include a register file 104 having multiple registers. For instance, the register file 104 may include a first register 106 (e.g., labeled CMDQ_BASE) that specifies a base address of the command queue 102. The register file 104 may include a second register 108 (e.g., labeled CMDQ_PROD) that is updated (e.g., by software) each time a command is inserted into the command queue 102. The register file 104 may include a third register 110 (e.g, labeled CMDQ_CONS) that is updated as commands in the command queue 102 are consumed (e.g., executed). A command may be considered consumed (e.g., processed) when the value observed in the third register 110 moves beyond the location of the command in the command queue 102. In some aspects, the third register 110 may be polled to determine whether a particular command included in the command queue 102 has been consumed.

The SMMU 100 may include a translation manager 112. In some aspects, the translation manager 112 may be configured to perform address translation. For instance, the translation manager 112 may perform virtual-to-physical address translations for the various components of the system-level device.

In some aspects, the translation manager 112 may manage access control policies for the system-level memory. For instance, the translation manager 112 may check the permissions associated with each translation to ensure that the system components only access authorized memory regions.

In some aspects, the translation manager 112 may detect and handle various memory-related faults, such as page faults, access violations, and translation errors. For instance, the translation manager 112 may report memory-related faults for appropriate error handling and recovery.

In some aspects, the SMMU 100 may include a queue manager 114. The queue manager 114 may be configured to control operation of the command queue 102. For instance, the queue manager 114 may control enqueuing (e. g, inserting), scheduling, and executing the commands stored in the command queue 102.

In some aspects, the SMMU 100 may include memory 116 (e.g., labeled CONFIG CACHE). The memory 116 may store configuration settings and parameters of the SMMU 100. Examples of such configuration settings and parameters may include translation table base addresses, access control policies, and fault handling policies. The memory 116 may also store configuration data for multiple VMs to allow the SMMU 100 to quickly switch between different memory management contexts and improve the efficiency and responsiveness of the SMMU 100 in virtualized systems.

### Example States of Command Queue

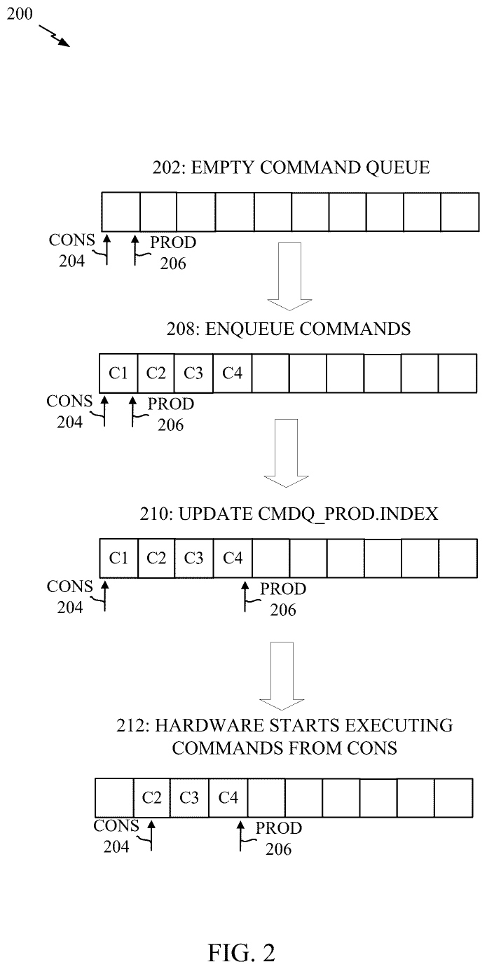

FIG. 2 depicts various states of an example command queue 200 for a SMMU according to some aspects of the present disclosure. For example, the command queue 200 may be implemented as the command queue 102 of the SMMU 100 discussed above with reference to FIG. 1.

At 202, the command queue 200 is empty. More specifically, the command queue 200 does not include any commands (e.g., memory management requests) waiting to be consumed (e.g., executed) by the SMMU. When the command queue 200 is empty, a consumer index 204 and a producer index 206 may point to a same location (e.g., index) within the command queue 200.

At 208, commands C1, C2, C3, C4 may be inserted into the command queue 200. For example, each of the commands may be a different memory management requests from one or more components (e.g., sensors, camera) of the system-level device. The commands C1, C2, C3, and C4 may be inserted into the command queue 200 in a first-in-first-out (FIFO) manner. For instance, C1 may be inserted into the command queue 200 first, followed by C2, C3, and C4. Furthermore, each of the commands may be located at a different location (e.g., index) within the command queue 200.

At 210, the producer index 206 may be updated. For instance, the producer index 206 may be updated to point to a location corresponding to the location of the first command (that is, C1) that was inserted into the command queue 200.

At 212, the SMMU may begin consuming the commands in the command queue 200. As the SMMU consumes each command, the consumer index 204 may be incremented to point to the location of the next command to be consumed. For example, once the SMMU consumes command C1, the consumer index 204 may be incremented to point to the location of the next command (that is, C2) to be consumed. This process may continue until all of the commands (that is, C1, C2, C3, and C4) have been consumed and the consumer index 204 and the producer index 206 once again point to a same location within the command queue 200.

Existing SMMUs do not prioritize commands in the command queue 200 based on a priority of the particular component that generated the commands. For example, the commands C1, C2, C3, C4 may be generated by a low-priority component (e.g., non-safe VM) of the system-level device. Furthermore, while the SMMU is processing the commands from the low-priority virtual component, the command queue 200 may receive a command (e.g., C5) from a high-priority component (e.g., safe VM) of the system-level device. Since existing SMMUs cannot prioritize commands, such as C5, from the high-priority component over commands, such as C1, C2, C3, and C4, from a low-priority component (e.g., non-safe VM), existing SMMUs consume the commands from the low-priority component first followed by the command from the high-priority component. As previously mentioned, this delay in consuming the command from the high-priority component may affect the performance of the high-priority component (and, in some instances, other components of the system-level device). As will be discussed with reference to FIGS. 3A-3C, example aspects of the present disclosure are directed to techniques for prioritizing commands from high-priority components over commands from low-priority components to eliminate (or at least reduce) the delay associated with consuming commands from high-priority components in such circumstances.

### Example System for Prioritizing Commands in a Command Queue of a SMMU

FIGS. 3A-3C depicts a system 300 for prioritizing commands in a command queue of a SMMU of a system-level device according to some aspects of the present disclosure. For simplicity, the system 300 will be in conjunction with the SMMU 100 discussed above with reference to FIG. 1.

The system 300 may include a hypervisor 302. The hypervisor 302 may be configured to prioritize inserting commands (e.g., memory management requests) in the command queue 102 based on a priority of each respective VM of a plurality of VMs 304 of the system-level device. More specifically, the hypervisor 302 may be configured to prioritize commands originating from a first type (e.g., safe) of VM over commands from a second type (e.g., non-safe) of VM. For instance, the hypervisor 302 may be configured to implement a command queue virtualization manager 306 (e.g., software) to prioritize commands received from the different VMs of the system-level device. In this manner, the system 300 according to the present disclosure may ensure timely completion of high-priority operations (e.g., safety operations). Additionally, the system 300 may improve responsiveness from direct memory access (DMA) masters in safety-critical use cases.

FIG. 3A depicts the system 300 in an initial state according to some aspects of the present disclosure. In the initial state, the hypervisor 302 may generate a virtual instance of the SMMU for each of a plurality of VMs 304 of the system-level device. For example, the hypervisor 302 may generate a first virtual instance 308 of the SMMU for a first VM 310, a second virtual instance 312 of the SMMU for a second VM 314, and a third instance 316 of the SMMU for a third VM 318.

The hypervisor 302 may also assign a priority ranking to each of the plurality of VMs 304. For instance, the hypervisor 302 may assign a highest priority ranking (e.g., denoted by 1) to the first VM 310, a lowest priority ranking (e.g., denoted by 3) to the second VM 314, and an intermediate priority ranking (e.g., denoted by 2) to the third VM 318. In some aspects, the hypervisor 302 may generate data 320 (e.g., a priority table) indicative of the assigned priority ranking for each of the plurality of VMs 304.

In some aspects, the hypervisor 302 may generate a physical command queue 330. The hypervisor 302 may also update the first register 106 (e.g., CMDQ_BASE) of of the SMMU (e.g., the SMMU 100 of FIG. 1) with the address of the physical command queue 330.

In some aspects, each of the plurality of VMs 304 may generate a virtual representation of the physical command queue 330. For instance, the first VM 310 may generate a first virtual command queue 340, the second VM 314 may generate a second virtual command queue 342, and the third VM 318 may generate a third virtual command queue 346. Each of the first virtual command queue 340, the second virtual command queue 342, and the third virtual command queue 346 may be a virtual representation of the physical command queue 330 (e.g., within a virtual address space of the respective VM).

For instance, the first virtual command queue 340 may be a virtual representation of the physical command queue 330 within a first virtual address space of the first VM 310. The second virtual command queue 342 may be a virtual representation of the physical command queue 330 within a second virtual address space (e.g., different from the first virtual address space) of the second VM 314. The third virtual command queue 344 may be a virtual representation of the physical command queue 330 within a third virtual address space (e.g., different from the first virtual address space and the second virtual address space) of the third VM 318.

FIG. 3B depicts the system 300 in a second state in which the system 300 is scheduling commands from VMs 304 of the system-level device according to some aspects of the present disclosure.

The VMs 304 may configure the SMMU and issue commands to reflect system-wide configuration updates. For instance, the first VM 310 may issue commands (e.g., denoted by A, B, C). The issued commands from the first VM 310 may be inserted into the first virtual command queue 340. Furthermore, the first VM 310 may also update a value of a register included in the first virtual instance 308 of the SMMU and indicative of the index of the producer in the first virtual command queue 340. More specifically, the value of the producer index may be updated to correspond to the location (e.g., index) of the last command (e.g., C) added to the first virtual command queue 340.

The command queue virtualization manager 306 may trap this activity with respect to the first virtual command queue 340 and the first virtual instance 308 of the SMMU. As will now be discussed, the command queue virtualization manager 306 may take different actions depending on the current state of the physical command queue 330. If the command queue virtualization manager 306 determines the physical command queue 330 is currently empty (that is, there are no commands stored in the physical command queue 330), the command queue virtualization manager 306 may insert the commands (e.g., ABC) into the physical command queue 330.

After inserting the commands into the physical command queue 330, the command queue virtualization manager 306 may update a producer index 334 of the physical command queue 330. For instance, the value of the producer index 334 may be updated to correspond to the location (e.g., index) in the physical command queue 330 associated with the last command (e.g., C) that was added to the physical command queue 330. With the producer index 334 updated, the SMMU (e.g., the SMMU 100 of FIG. 1) may begin consuming (e.g., executing) the commands and the commands until the consumer index 332 and the producer index 334 once again point to the same location (e.g., index) within the physical command queue 330.

In some aspects, while the SMMU is consuming the commands (e.g., A, B, and C) enqueued in the physical command queue 330 and originating from the first VM 310, the command queue virtualization manager 306 may trap activity with respect to the second virtual command queue 342 and the second virtual instance 312 of the SMMU. For instance, the second VM 314 may issue commands (e.g., denoted by P, Q, R, and S) that are inserted into the second virtual command queue 342. Furthermore, the second VM 314 may update a value of a register included in the second virtual instance 312 of the SMMU and indicative of the index of the producer in the second virtual command queue 342. More specifically, the value of the producer index may be updated to correspond to the location (e.g., index) of the last command (e.g., S) added to the second virtual command queue 342.

The command queue virtualization manager 306 may once again determine the current state of the physical command queue 330. Since the physical command queue 330 includes commands (e.g., A, B, and C), the command queue virtualization manager 306 may determine whether the commands (e.g., P, Q, R, and S) originating from the second VM 314 take priority over the commands (e.g., A, B, and C) originating from the first VM 310. For instance, based on the data 320 indicative of the assigned priority for each of the VMs 304, the command queue virtualization manager 306 may determine the first VM 310 (e.g., safe VM) has a higher priority than the second VM 314 and, thus, the commands (e.g., A, B, and C) originating from the first VM and already inserted into the physical command queue 330 do not need to be preempted by the commands (e.g., P, Q, R, and S) originating from the second VM 314. More specifically, since the commands originating from the second VM 314 are lower priority than the commands originating from the first VM 310, the SMMU may continue consuming the commands (e.g., A, B, C) in the physical command queue 330 and the command queue virtualization manager 306 may insert the commands originating from the second VM 314 into the physical command queue 330 such that the commands (e.g., P, Q, R, and S) are behind the commands (e.g., A, B, and C) and thus will not be consumed until the last command (e.g., C) of the command originating from the first VM 310 is consumed.

FIG. 3C depicts the system 300 in a third state in which a current production session from a low priority VM is in progress and a higher priority VM requests commands according to some aspects of the present disclosure.

As illustrated, a current production session 350 involving commands (e.g., P, Q, R, and S) originating from the second VM 314 (e.g., having lowest priority) may be in progress when the first VM 310 (e.g., having the highest priority) generates commands (e.g., A, B, and C). In such an instance, the command queue virtualization manager 306 may pause the current production session 350. With the current production session 350 paused, the command queue virtualization manager 306 may shift (e.g., to the right) the commands (e. g, Q, R, and S) originating from the second VM 314 that have yet to be consumed (e.g., executed). More specifically, the command queue virtualization manager 306 may shift the commands (e.g., Q, R, and S) by the number of commands (e.g., A, B, C) originating from the first VM 310. In this manner, the command queue virtualization manager 306 may allocate space in the physical command queue 330 for the commands from the first VM 310 such that those commands (e. g, A, B, and C) are consumed by the SMMU before the remaining commands (e.g., Q, R, and S) from the second VM 314. The command queue virtualization manager 306 may also increment the producer index 334 by the length of commands in the first virtual command queue 340 to generate the updated producer session 360. Then, the SMMU may continue consuming commands starting from the consumer index 332 and may continue until the consumer index 332 is less than or equal to the producer index 334.

In some aspects, the commands (e.g., Q, R, S) originating from the second VM 314 that have yet to be consumed may be shifted behind commands (e.g., X and Y) originating from the third VM 318 having a higher priority than the second VM 314. For instance, the commands originating from the third VM 318 may be received simultaneously with the commands originating from the first VM 310.

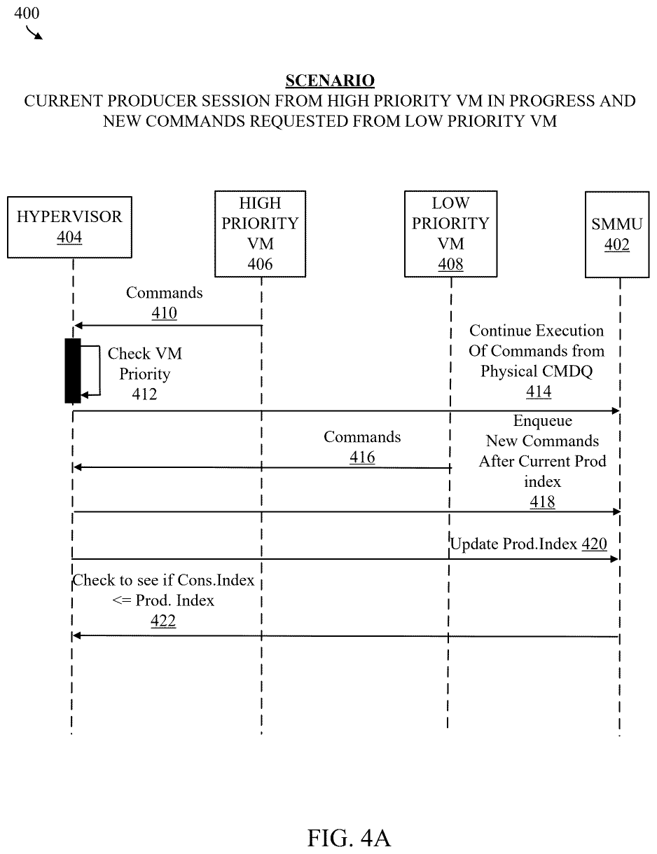

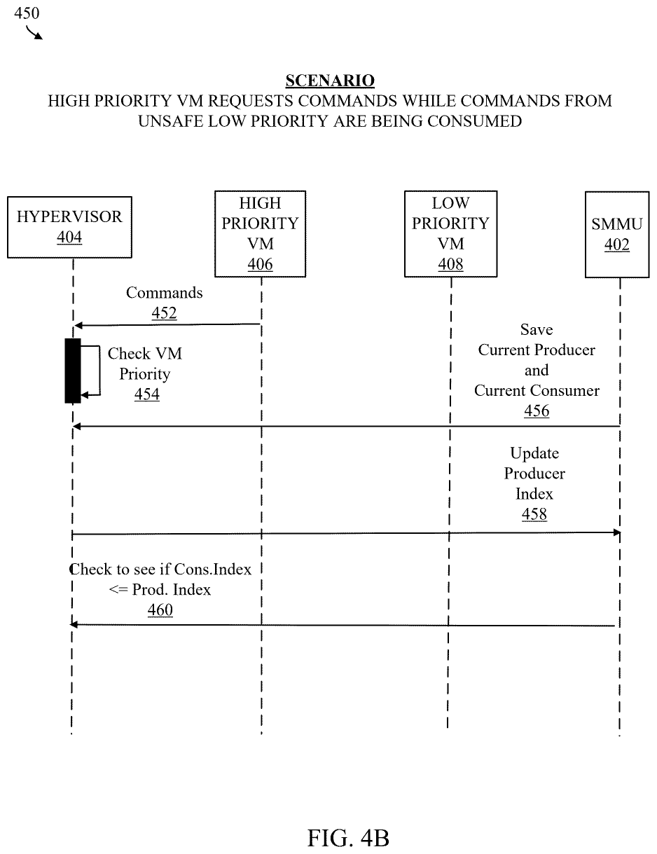

FIG. 4A depicts a sequence diagram 400 for a scenario in which commands from a lower priority VM are requested while commands from a higher priority VM are being consumed by a SMMU according to some aspects of the present disclosure. The steps of the sequence diagram 400 may involve different components, such as a SMMU 402, a hypervisor 404, a high-priority VM 406, and a low-priority VM 408.

At (410), the hypervisor 404 receives commands from the high-priority VM 406 (e.g., the first VM 310 of FIGS. 3A-3C). For instance, the high-priority VM 406 may generate a virtual command queue (e.g., the first virtual command queue 340 of FIGS. 3A-3C) and may insert (e.g., enqueue) the received commands into the virtual command queue and update a value for a producer index associated with the virtual command queue. For example, the hypervisor 404 may generate a virtual instance of a SMMU, and the high-priority VM 406 may update a register of the virtual instance of the SMMU based on the number of commands the high-priority VM 406 inserted into the virtual instance of the command queue.

At (412), the hypervisor 404 may determine a priority of the high-priority VM 406 relative to other VMs. For instance, the hypervisor 404 may determine the high-priority VM 406 is the highest priority VM according to data (e.g., data 320 in FIGS. 3A-3C) ranking the priority of multiple VMs.

At (414), the hypervisor 404 may insert the commands received at (410) into the command queue of the SMMU 402 such that the commands may be consumed (e.g., executed) by the SMMU. In some aspects, the hypervisor may, in addition to inserting the commands into the command queue, adjust a producer index associated with the command queue. For example, the hypervisor 404 may increment the producer index by an amount corresponding to the total number of commands received from the high-priority VM 406 at (410).

At (416), the hypervisor 404 may receive commands from the low-priority VM 408. For instance, the low-priority VM 408 may generate a virtual command queue (e.g., the second virtual command queue 342 of FIGS. 3A-3C) and may insert (e.g., enqueue) commands into the virtual command queue and update a value for a producer index associated with the virtual command queue. For example, the low-priority VM 408 may update a register of a virtual instance of the SMMU that is indicative of a value for a producer index associated with the virtual command queue. More specifically, the low-priority VM 408 may increment the value for the producer index by the number of commands the low-priority VM inserted into the virtual instance of the command queue.

At (418), the hypervisor 404 may add the commands from the low-priority VM 408 into the command queue such that the SMMU 402 after the SMMU 402 finishes consuming the commands received from the high-priority VM 406.

At (420), the hypervisor 404 updates the producer index of the command queue based on the commands inserted from the low-priority VM 408. For example, the hypervisor 404 may increment the producer index by the number of the commands received from the low-priority VM 408. In this manner, the updated producer index may correspond to the location of the last command added to the command queue.

At (422), commands in the command queue may be consumed until the command queue is empty. For instance, the command queue may determine to be empty when the consumer index of the command queue is less than or equal to the producer index.

FIG. 4B depicts a sequence diagram 450 for a scenario in which commands from a higher-priority VM are requested while commands from a lower-priority VM are being consumed by a SMMU according to some aspects of the present disclosure. The steps of the sequence diagram 400 may involve different components, such as the SMMU 402, the hypervisor 404, the high-priority VM 406, and the low-priority VM 408 discussed above with reference to FIG. 4A.

At (452), the hypervisor 404 receives commands from the high-priority VM 406 (e.g., the first VM 310 of FIGS. 3A-3C). For instance, the high-priority VM 406 may generate a virtual command queue (e.g., the first virtual command queue 340 of FIGS. 3A-3C) and may insert (e.g., enqueue) commands into the virtual command queue and update a value for a producer index associated with the virtual command queue. For example, the hypervisor 404 may generate a virtual instance of a SMMU, and the high-priority VM 406 may update a register of the virtual instance of the SMMU based on the number of commands the high-priority VM 406 inserted into the virtual instance of the command queue.

At (454), the hypervisor 404 may determine a priority of the high-priority VM 406 relative to other VMs. For instance, the hypervisor 404 may determine the high-priority VM 406 is the highest priority VM according to data (e.g., data 320 in FIGS. 3A-3C) ranking the priority of multiple VMs.

At (456), the current production session involving the commands originating from the low-priority VM 408 may be paused and the current consumer index and the current producer index for the current production session may be saved.

At (458), the producer index based on the commands from the high-priority VM 406 that are being inserted into the command queue. For instance, the value of the producer index may be incremented by the total number of commands originating from the high-priority VM 406 and being inserted into the command queue.

At (460), consumption of commands in the command queue may resume according to the updated producer session having the updated producer index and consumption of commands may continue until the command queue is empty. For instance, the command queue may be determined to be empty when the consumer index of the command queue is less than or equal to the producer index.

### Example Method for Prioritizing Commands for a Command Queue of a System Memory Management Unit

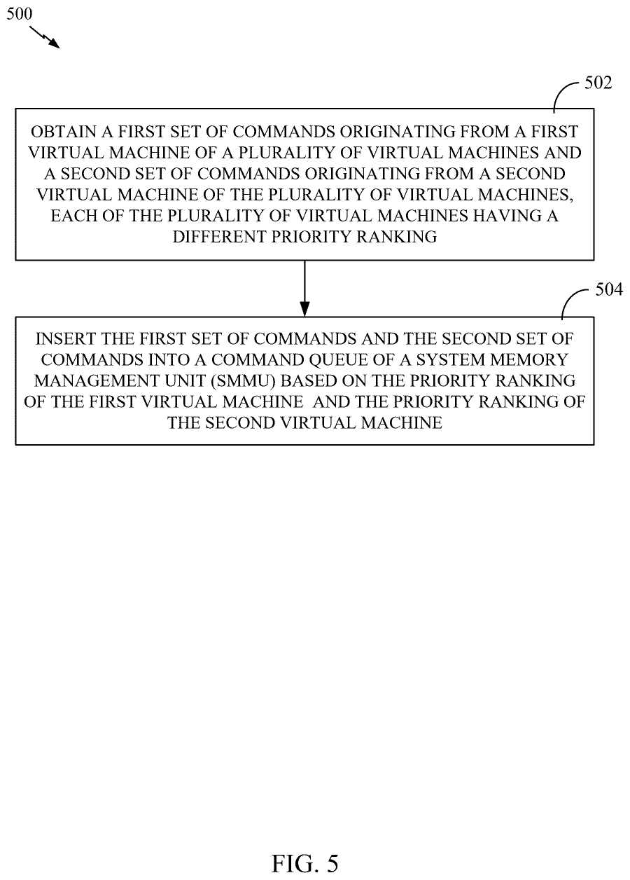

FIG. 5 depicts an example method 500 for prioritizing commands for a command queue of a SMMU according to some aspects of the present disclosure. For example, the method 500 may be performed by the system 300 of FIGS. 3A-3C, such as by the command queue virtualization manager 306. Furthermore, although FIG. 5 depicts steps performed in a particular order for purposes of illustration and discussion, the method 500 discussed herein is not intended to be limited to any particular order or arrangement. One skilled in the art, using the disclosure provided herein, will appreciate that various steps of the method 500 can be omitted, rearranged, combined and/or adapted in various ways without deviating from the scope of the present disclosure.

At (502), the method 500 includes obtaining a first set of commands originating from a first virtual machine of a plurality of virtual machines and a second set of commands originating from a second virtual machine of the plurality of virtual machines, each of the plurality of virtual machines having a different priority ranking. In some aspects, the first set of commands and the second set of commands may be obtained simultaneously.

At (504), the method 500 includes inserting the first set of commands and the second set of commands into a command queue of a system memory management unit (SMMU) based on the priority ranking of the first virtual machine and the priority ranking of the second virtual machine.

### Example Processing System

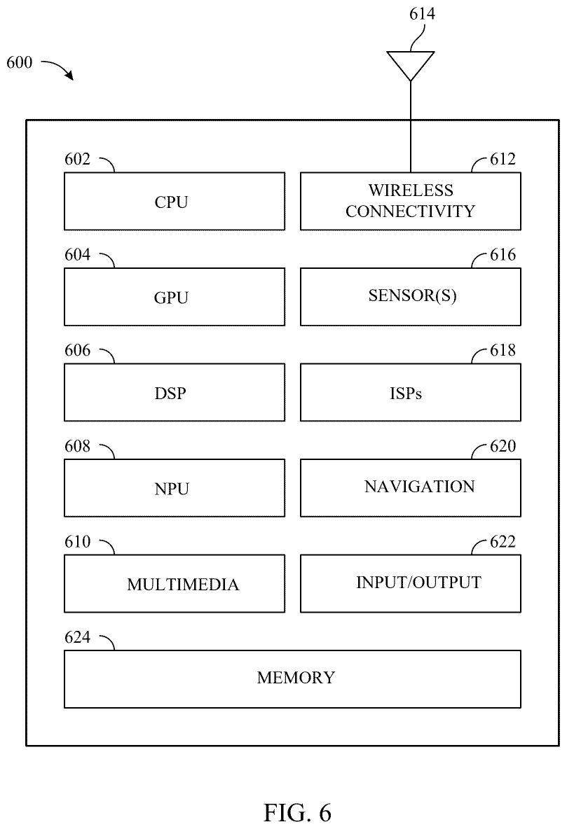

In some aspects, the system 300 depicted in FIGS. 3A-3C may be implemented in a processing system. FIG. 6 depicts an example processing system 600. Although depicted as a single system for conceptual clarity, in some aspects, as discussed above, the operations described below with respect to the processing system 600 may be distributed across any number of devices or systems.

The processing system 600 includes a central processing unit (CPU) 602. Instructions executed at the CPU 602 may be loaded, for example, from a memory 624 associated with the CPU 602.

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a SoC, while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 612 is further coupled to one or more antennas 66.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS), as well as inertial positioning system components.

The processing system 600 may also include one or more input and/or output devices 622, such as screens, touch-sensitive surfaces (including touch-sensitive displays), physical buttons, speakers, microphones, and the like.

The processing system 600 also includes the memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

Generally, the processing system 600 and/or components thereof may be configured to perform the methods described herein.

Notably, in other aspects, elements of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 may be distributed between multiple devices.

### Example Clauses

In addition to the various aspects described above, specific combinations of aspects are within the scope of the disclosure, some of which are detailed below:

Aspect 1: A method performable by a hypervisor, comprising: obtaining a first set of commands originating from a first virtual machine of a plurality of virtual machines and a second set of commands originating from a second virtual machine of the plurality of virtual machines, each of the plurality of virtual machines having a different priority ranking; and inserting the first set of commands and the second set of commands into a command queue of a system memory management unit (SMMU) based on the priority ranking of the first virtual machine and the priority ranking of the second virtual machine.

Aspect 2: The method of Aspect 1, wherein: obtaining the first set of commands occurs before obtaining the second set of commands; and inserting the first set of commands into the command queue occurs before inserting the second set of commands into the command queue.

Aspect 3: The method of Aspect 2, wherein the priority ranking of the first virtual machine is higher than the second virtual machine.

Aspect 4: The method of Aspect 2, wherein the priority ranking of the first virtual machine is lower than the priority ranking of the second virtual machine and inserting the second set of commands into the command queue comprises: pausing a current production session of the command queue, the current production session including the first set of commands originating from the first virtual machine; modifying the current production session by moving one or more commands included in the first set of commands to create space between the one or more commands and a consumer index of the command queue; and inserting the second set of commands into the space to generate an updated production session.

Aspect 5: The method of Aspect 4, further comprising: updating a producer index of the command queue after the moving.

Aspect 6: The method of Aspect 5, wherein updating the producer index comprises incrementing the producer index by a number corresponding to a total number of commands included in the second set of commands.

Aspect 7: The method of Aspect 1, wherein obtaining the first set of commands originating from the first virtual machine and the second set of commands originating from the second virtual machine comprises: obtaining the first set of commands from a virtual command queue generated by the first virtual machine; and obtaining the second set of commands from a virtual command queue generated by the second virtual machine.

Aspect 8: The method of Aspect 1, wherein obtaining the second set of commands originating from the second virtual machine occurs simultaneously with obtaining the first set of commands originating from the first virtual machine.

Aspect 9: The method of Aspect 1, wherein the first virtual machine has a higher priority ranking than the second virtual machine, and wherein the first virtual machine is operable to perform time-sensitive operations, and wherein the second virtual machine is operable to perform non-time sensitive operations.

Aspect 10: An apparatus, comprising: a system memory management unit (SMMU) comprising a command queue; and a hypervisor configured to: obtain a first set of commands originating from a first virtual machine of a plurality of virtual machines and a second set of commands originating from a second virtual machine of the plurality of virtual machines, each of the plurality of virtual machines having a different priority ranking; and insert the first set of commands and the second set of commands into the command queue of the SMMU) based on the priority ranking of the first virtual machine and the priority ranking of the second virtual machine.

Aspect 11: The apparatus of Aspect 10, wherein the hypervisor is configured to: obtain the first set of commands before the second set of commands; and insert the first set of commands into the command queue before inserting the second set of commands into the command queue.

Aspect 12: The apparatus of Aspect 11, wherein the priority ranking of the first virtual machine is higher than the priority ranking of the second virtual machine.

Aspect 13: The apparatus of Aspect 11, wherein: the priority ranking of the first virtual machine is lower than the priority ranking of the second virtual machine; and to insert the second set of commands into the command queue, the hypervisor is configured to: pause a current production session of the command queue, the current production session including the first set of commands originating from the first virtual machine; modify the current production session by moving one or more commands included in the first set of commands to create space between the one or more commands and a consumer index of the command queue; and insert the second set of commands into the space to generate an updated production session.

Aspect 14: The apparatus of Aspect 13, wherein the hypervisor is further configured to: update a producer index of the command queue after modifying the current production session.

Aspect 15: The apparatus of Aspect 14, wherein to update the producer index, the hypervisor is configured to increment the producer index by a number corresponding to a total number of commands included in the second set of commands.

Aspect 16: The apparatus of Aspect 10, wherein to obtain the first set of commands and the second set of commands, the hypervisor is configured to: obtain the first set of commands from a virtual command queue generated by the first virtual machine; and obtain the second set of commands from a virtual command queue generated by the second virtual machine.

Aspect 17: The apparatus of Aspect 10, wherein the first virtual machine has a higher priority ranking than the second virtual machine, and wherein the first virtual machine is operable to perform time-sensitive operations, and wherein the second virtual machine is operable to perform non-time sensitive operations.

Aspect 18: The apparatus of any of Aspects 10 to 17, wherein the first set of commands and the second set of commands each include one or more memory management requests.

Aspect 19: The apparatus of any of Aspects 10 to 18, wherein the hypervisor is configured to simultaneously obtain the first set of commands and the second set of commands.

Aspect 20: An apparatus, comprising: means for obtaining a first set of commands originating from a first virtual machine of a plurality of virtual machines and a second set of commands originating from a second virtual machine of the plurality of virtual machines, each of the plurality of virtual machines having a different priority ranking; and means for inserting the first set of commands and the second set of commands into a command queue of a system memory management unit (SMMU) based on the priority ranking of the first virtual machine and the priority ranking of the second virtual machine.

### Additional Considerations

The various operations of methods described above may be performed by any suitable means capable of performing the corresponding functions. The means may include various hardware and/or software components(s) module(s), including, but not limited to a circuit or processor. Generally, where there are operations illustrated in figures, those operations may have corresponding counterpart means-plus-function components with similar numbering.

For example, means means for obtaining a first set of commands originating from a first virtual machine of a plurality of virtual machines and a second set of commands originating from a second virtual machine of the plurality of virtual machines may be performed by a hypervisor, such as the hypervisor 302 discussed above with reference to FIGS. 3A-3C. In addition, means for inserting the first set of commands and the second set of commands into a command queue of a system memory management unit (SMMU) based on the priority ranking of the first virtual machine and the priority ranking of the second virtual machine may be performed by the hypervisor.

The preceding description is provided to enable any person skilled in the art to

practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method performable by a hypervisor, comprising:
obtaining a first set of commands originating from a first virtual machine of a plurality of virtual machines and a second set of commands originating from a second virtual machine of the plurality of virtual machines, each of the plurality of virtual machines having a different priority ranking; and
inserting the first set of commands and the second set of commands into a command queue of a system memory management unit (SMMU) based on the priority ranking of the first virtual machine and the priority ranking of the second virtual machine.

2. The method of claim 1, wherein:
obtaining the first set of commands occurs before obtaining the second set of commands; and
inserting the first set of commands into the command queue occurs before inserting the second set of commands into the command queue.

3. The method of claim 2, wherein the priority ranking of the first virtual machine is higher than the second virtual machine.

4. The method of claim 2, wherein the priority ranking of the first virtual machine is lower than the priority ranking of the second virtual machine and inserting the second set of commands into the command queue comprises:
pausing a current production session of the command queue, the current production session including the first set of commands originating from the first virtual machine;
modifying the current production session by moving one or more commands included in the first set of commands to create space between the one or more commands and a consumer index of the command queue; and
inserting the second set of commands into the space to generate an updated production session.

5. The method of claim 4, further comprising:
updating a producer index of the command queue after the moving.

6. The method of claim 5, wherein updating the producer index comprises incrementing the producer index by a number corresponding to a total number of commands included in the second set of commands.

7. The method of claim 1, wherein obtaining the first set of commands originating from the first virtual machine and the second set of commands originating from the second virtual machine comprises:
obtaining the first set of commands from a virtual command queue generated by the first virtual machine; and
obtaining the second set of commands from a virtual command queue generated by the second virtual machine.

8. The method of claim 1, wherein obtaining the second set of commands originating from the second virtual machine occurs simultaneously with obtaining the first set of commands originating from the first virtual machine.

9. The method of claim 1, wherein the first virtual machine has a higher priority ranking than the second virtual machine, and wherein the first virtual machine is operable to perform time-sensitive operations, and wherein the second virtual machine is operable to perform non-time sensitive operations.

10. An apparatus, comprising:
a system memory management unit (SMMU) comprising a command queue; and
a hypervisor configured to:
obtain a first set of commands originating from a first virtual machine of a plurality of virtual machines and a second set of commands originating from a second virtual machine of the plurality of virtual machines, each of the plurality of virtual machines having a different priority ranking; and
insert the first set of commands and the second set of commands into the command queue of the SMMU based on the priority ranking of the first virtual machine and the priority ranking of the second virtual machine.

11. The apparatus of claim 10, wherein the hypervisor is configured to:
obtain the first set of commands before the second set of commands; and
insert the first set of commands into the command queue before inserting the second set of commands into the command queue.

12. The apparatus of claim 11, wherein the priority ranking of the first virtual machine is higher than the priority ranking of the second virtual machine.

13. The apparatus of claim 11, wherein:
the priority ranking of the first virtual machine is lower than the priority ranking of the second virtual machine; and
to insert the second set of commands into the command queue, the hypervisor is configured to:
pause a current production session of the command queue, the current production session including the first set of commands originating from the first virtual machine;
modify the current production session by moving one or more commands included in the first set of commands to create space between the one or more commands and a consumer index of the command queue; and
insert the second set of commands into the space to generate an updated production session.

14. The apparatus of claim 13, wherein the hypervisor is further configured to:
update a producer index of the command queue after modifying the current production session.

15. The apparatus of claim 14, wherein to update the producer index, the hypervisor is configured to increment the producer index by a number corresponding to a total number of commands included in the second set of commands.

16. The apparatus of claim 10, wherein to obtain the first set of commands and the second set of commands, the hypervisor is configured to:
obtain the first set of commands from a virtual command queue generated by the first virtual machine; and
obtain the second set of commands from a virtual command queue generated by the second virtual machine.

17. The apparatus of claim 10, wherein the first virtual machine has a higher priority ranking than the second virtual machine, and wherein the first virtual machine is operable to perform time-sensitive operations, and wherein the second virtual machine is operable to perform non-time sensitive operations.

18. The apparatus of claim 10, wherein the first set of commands and the second set of commands each include one or more memory management requests.

19. The apparatus of claim 10, wherein the hypervisor is configured to simultaneously obtain the first set of commands and the second set of commands.

20. An apparatus, comprising:
means for obtaining a first set of commands originating from a first virtual machine of a plurality of virtual machines and a second set of commands originating from a second virtual machine of the plurality of virtual machines, each of the plurality of virtual machines having a different priority ranking; and
means for inserting the first set of commands and the second set of commands into a command queue of a system memory management unit (SMMU) based on the priority ranking of the first virtual machine and the priority ranking of the second virtual machine.
